(19) United States
(12) Patent Application Publication
(10) Pub. No.: US 2013/0269546 A1
(43) Pub. Date: Oct. 17, 2013

(54) DISC PRESS

(71) Applicants: Eino Sivonen, Tampere (FI); Kyösti Valta, Tampere (FI)

(72) Inventors: Eino Sivonen, Tampere (FI); Kyösti Valta, Tampere (FI)

(21) Appl. No.: 13/994,196

(22) PCT Filed: Dec. 15, 2011
(86) PCT No.: PCT/FI2011/051109

§ 371 Date: Jun. 14, 2013

(30) Foreign Application Priority Data
Dec. 17, 2010 (FI) 20106340

(51) Int. Cl. B30B 9/20; B30B 9/26

(52) U.S. Cl. CPC B30B 9/20; B30B 9/26
USPC 100/37; 100/118

(57) ABSTRACT

An apparatus for processing and compressing pulp, includes a circular perforated sieve base disc and at least one roll wheel circulating and rotating on the sieve base disc, where the sieve base disc and the at least one roll wheel rotating on the sieve base disc are shaped as bevel gears and make up a bevel gear assembly, by which the rotating force can be introduced in the gears of the bevel gear assembly to be partly converted to a compressive force for compressing the pulp to be processed through perforations in the bevel gear like sieve base disc.

### FIELD OF THE INVENTION

The invention relates to an apparatus for homogenizing and processing pulp, more precisely an apparatus for subjecting pulp mechanically to forces for changing the properties of the pulp.

### BACKGROUND OF THE INVENTION

In industry, various pulps are generally processed as a downstream operation for the primary production process of pulp. The processing of pulp, for example for removing moisture and for compressing the pulp, is very similar, irrespective of the field of industry; similar needs for processing the pulp are present in the range from food industry to paper industry. Depending on the quality of the final product desired, the pulp containing the main component can be blended with other pulp components, whose mixing to each other is arranged mechanically. Depending on the quality of the components, the mechanical mixing may also start a chemical process whose final result is, in turn, reacted pulp to be used as material for the next processing step in the process chain.

Various pulps are used to produce various consumer goods. For example in the food industry, crude pulp is compressed to produce compound feed pellets for domestic animals; for example macaroni and other granular food products are produced from pulp made of cereal products; in the wood processing industry, for example pellets for heating are made of wood pulp; and so on.

An established way to bring the raw material to a form that is processable in a more lucrative way, that is, to a smaller volume, is to compress the material by a disc press mechanically through a perforated structure to remove water and other possible liquid chemicals bound to the material from the pulp. For compressing the pulp, grinding mills are used, as presented, for example, in the European patent of German equipment manufacturer Kahl dated 1982: EP0101614A3: Method and device for the determination of the distance between the die and the press rollers in a grinding mill with vertical rollers.

The patent discloses an edge runner mill in which rotating edge runner wheels, placed on top of a perforated grinding disc and driven by a motor, compress pulp through the perforations of the perforated disc.

In the grinding mill of prior art, the point that is most critical for the operation is placed between the wheel and the grinding plane of the edge runner mill. Depending on the wetness of the pulp to be compressed and on the speed of rotation of the wheel of the edge runner mill, the pulp to be compressed is wedged the faster, the drier the pulp to be compressed is, and is thus no longer compressed through a die table at the speed of rotation of the wheel of the edge runner mill. Because the ends of the wheel pass a path of a different length on the curve defined by the base disc in a given time, the optimal speed of compression by the press, determined by the speed of motion of the wheel and by the material to be compressed will only be realized at a given point on the contact surface between the wheel and the base disc.

The running speed of the wheel is always higher at the outer edge than at the inner edge of the die table; therefore, in the immediate vicinity of the wheel, the flow rate of the pulp caused by the thrusting movement of the wheel is also greater in relation to the pulp on the inner base disc. The pulp thrusting forward at the higher speed will start to skid on the base disc in front of the edge runner wheel on the side of the outer periphery earlier than on the inner periphery of the base disc. In this way, the processing of the pulp generates heat which easily solidifies pulp on top of the grinding disc and in the perforations. The heated and solidified pulp obstructs the perforations of the press and eventually prevents the operation of the press. Thus, the compressing must be interrupted to drill out the perforations obstructed by solidified pulp. Because packing up is dependent on the friction between the pulp to be compressed and the base disc, the skidding of the pulp also sets edge conditions on the physical properties of the pulp to be compressed, such as the viscosity of the pulp and the friction between the surface of the press and the pulp.

Therefore, it is necessary to improve the operation of the structure of the disc press, to prevent the skidding of the pulp in the grinding mill, and to be able to run pulps of different consistencies through the press.

### BRIEF SUMMARY OF THE INVENTION

The press apparatus according to the invention is characterized in what will be presented in the characterizing part of claim 1. The method according to the invention is characterized in what will be presented in the characterizing part of claim 13.

The invention relates to an apparatus and a method for compressing various pulps. The operation of the apparatus of the invention is arranged so that the pulp to be compressed cannot solidify and pack up on the press surfaces of the apparatus. The invention comprises a sieve disc having the shape of a bevel gear, and an edge runner wheel having the shape of a bevel gear, which together with their supporting structures make up a bevel gear assembly.

Due to the structure of the apparatus according to the invention, a larger variety of materials can be compressed than before. On the basis of tests carried out, it has been found that the invention makes it possible to use drier pulp material to be compressed than before, without the problems involved in the compressing processes of prior art. According to the tests, the energy efficiency of the processing of the pulp and thereby the efficiency of the compressing process are also increased, whereas the material throughput time decreases.

Another advantage of the invention is the fact that the components needed for implementing the invention can be installed in apparatus frames already on the market, with slight modifications. It is thus cost efficient to introduce the invention in press apparatuses already existing.

### DESCRIPTION OF THE DRAWINGS

In the following, the invention will be described in more detail with reference to the appended drawings, in which

FIG. 1 shows a disc press of prior art,

FIG. 2 shows a partial assembly of the press, which is essential for the operation, seen in a slanted view from above,

FIG. 3 shows a partial configuration which is advantageous for the operation of the press, in a cross-sectional view.

### DETAILED DESCRIPTION OF THE INVENTION

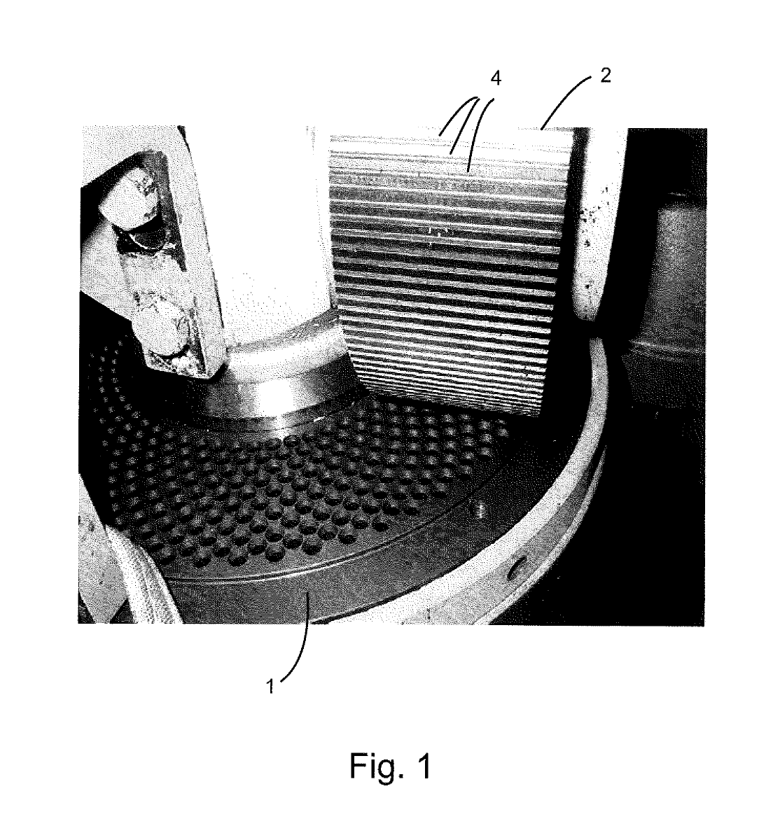

FIG. 1 shows a press of prior art, that is, a pulp grinding mill, whose operation is characterized in that a cylindrical roll 2 connected mechanically to the apparatus is rolled on top of a perforated base disc 1, a so-called matrix disc or sieve base disc. Terms often used for this roll include a roller mill roll, a pan roll, or an edge runner wheel. Hereinbelow, we shall call this functional part of the apparatus an edge runner wheel. Grooves 4 are machined on the surface of the edge runner wheel, to increase the friction surface on the wheel. It is typical of the operation of the apparatus that the pulp to be compressed is supplied to the apparatus from above, after which the pulp moves, boosted by the movement of the edge runner wheel, through the sieve base disc to the lower part of the press, where the compressed pulp can be processed further, for example by cutting pellets of a given length from the compressed pulp strip, by moving the pulp to an intermediate storage, and so on.

The mechanical compressing of the pulp not only reduces or compacts the volume of the pulp to be compressed but also enables forming of the material to be compressed; in the press, the material can be mixed to a uniform consistency, i.e. homogenized; different pulp components can be blended by compressing; and components can be bound to each other at a high pressure.

A press similar to that shown in FIG. 1 is used to generate a local and transient pressure on each point of the sieve base disc 1 as a function of time. The pressure directed to the material to be compressed increases the temperature of the material to be compressed, momentarily and locally. The press also generates forces which cause beating and stretching transformations in the pulp to be worked. Typically, an apparatus similar to that shown in FIG. 1 can be used to work a pulp flow in which the water content of the material to be worked is 80% or more. Due to the wetness of the mass, the compression efficiency of a press similar to that shown in FIG. 1 remains low, because the material flow passed through the press must be sufficiently limited so that the press would maintain its functionality and the pulp would not skid on the base disc 1 in front of the edge runner wheel 2, generating friction and burning the material.

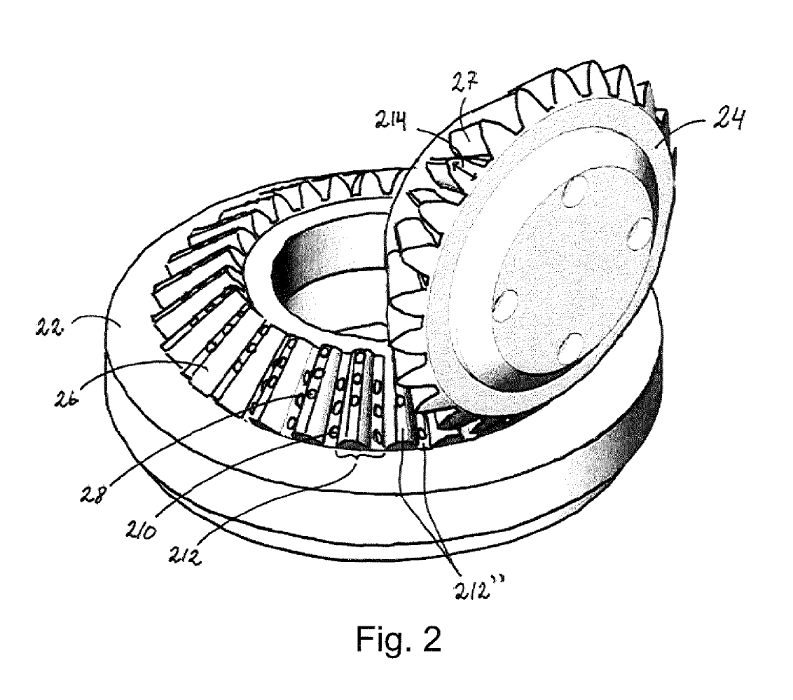

FIG. 2 shows the components substantial for the press arrangement of an embodiment of the invention, removed from the surrounding casing and supporting structures. The sieve base disc 22 according to the invention is worked as a counter piece for a bevel gear in such a way that the surfaces of the teeth 26 of the counter piece 22 for the bevel gear, with their sides, butt ends and tips make up a uniform surface which provides a supporting force for the compressive force as a base disc 1 of prior art does. The perforation of the sieve base disc 22 according to the invention and having the shape of a bevel gear is implemented at the butt ends 210 and tips 28 of the teeth 26 in such a way that perforations worked through the base disc extend in the direction of the symmetry axis B of the base disc, to facilitate the throughput of the pulp and thereby the proceeding of the compression.

Stretching is an essential mechanism of transformation by the apparatus according to the invention; it is known to be advantageous in view of mixing of the pulp but difficult to produce by a mechanical apparatus of prior art. In the invention, the extrusion flow produced by compressing is expressly stretching.

The edge runner wheel 24 of the press according to the invention is worked to the shape of a bevel gear in such a way that the toothing 27 of the bevel gear like edge runner wheel 24 matches the toothing of the sieve base disc 22, forming a bevel gear assembly, in which a rotation movement transmitted to one of the gears (22, 24) will also cause a transmission of the force to the other gear (22, 24), in the ratio of the toothings.

The width 212 of the modules of the teeth of the gears, on the other hand the height 214 of the tooth, the shape of the tip of the tooth, as well as the line of teeth of said gear have an effect on what kind of forces are exerted on the sides of the tooth during the transmission of the movement. This description has been confined to a straight line of teeth only, but also diagonal and helical lines are alternative embodiments for implementing the invention.

The height 214 of the teeth of the gears, as well as the pitch of the teeth which can be measured from the width 212 of the module, determine the size of the shots in which the pulp is compressed. In the compressing arrangement of the described type, the maximum compression always takes place at the point where the teeth 26, 27 of both gears engaged in the compressing are completely abutting. Thus, the pulp to be completely compressed at a time is always placed in the trough-like space delimited by the teeth of the gears engaged in the compression at the time, and preventing the pulp to be compressed from skidding in front of the gear-like edge runner wheel 24 as the compression proceeds on the sieve base disc 22 when the gears are rotating. At the compressing stage, the planar surfaces 212″ of the teeth of the gears are completely pressed against each other in one pair of a clearing trough and a tooth at a time. Thus, the component of compressive force derived from the rotational force of the gear in said pair of a clearing trough and a tooth is directed entirely in the direction of imaginary perpendiculars of perforations 28, 210 in the sieve base disc 22. Because the compressive force extends completely in the direction of the perpendiculars of the perforations 28, 210, the pulp in the immediate vicinity of the compressing surface is not subjected to any force component transverse to the perpendiculars of the perforations 28, 210, which would push the pulp in the direction of rotation of the edge runner wheel 24 on the sieve base disc 22. Thus, the press operates in an energy efficient way, as the compressive force can be directed correctly.

The trough-like space delimited by the teeth of the gears, into which space the material to be compressed is driven before the local compressing is started, is advantageous in view of various pulps to be compressed. Because the flank surfaces of the teeth 26 provide a supporting surface for the pulp to be compressed, the pulp to be compressed may contain more solid components without starting to skid in front of the edge runner wheel 24. The increased friction surface also makes it possible to keep the press apparatus loaded with a greater pulp flow without the pulp skidding between the edge runner wheel 24 and the gear-like sieve base disc 22. For these reasons, the efficiency of the press apparatus of the inventive type is significantly improved, compared with presses of prior art.

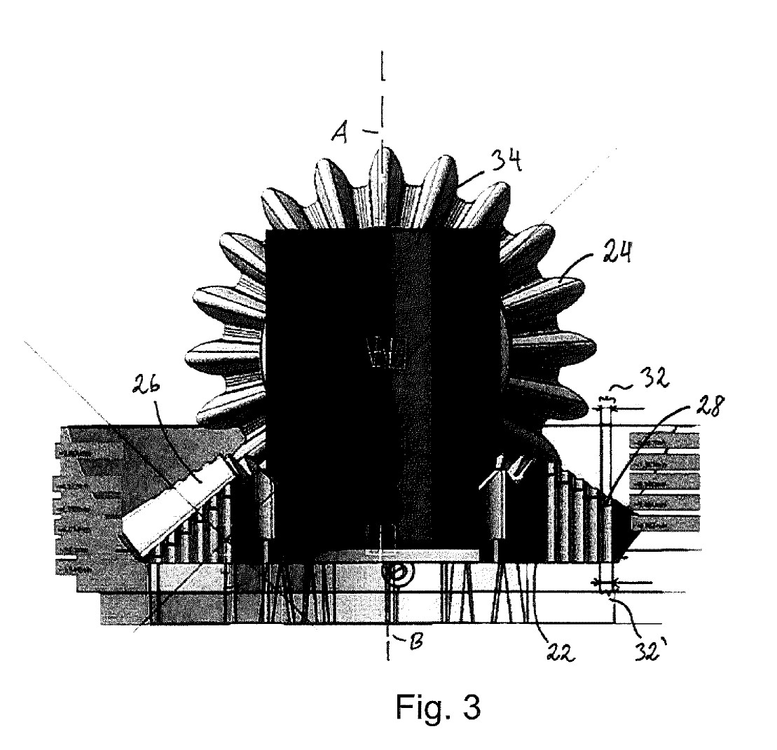

FIG. 3 shows components of an embodiment of the invention in a cross-sectional view. FIG. 3 shows a sieve base disc 22 which has the shape of a bevel gear and whose symmetry axis and simultaneously a possible rotation axis is B; an edge runner wheel 24 having the shape of a bevel gear; and a rotating shaft 34 with a rotation axis A.

Furthermore, FIG. 3 shows perforations 28 worked in the bevel gear shaped sieve base disc 22 and extending in the direction of the symmetry axis B of the sieve base disc 22. The perforations 28 shown in the figure are placed at the tip of a tooth 26 in the gear of the sieve base disc 22, but similar perforations are also worked in the butt end 212″ of the tooth, as shown in FIG. 2. FIG. 3 shows that the perforation 28 is worked in such a way that the diameter 32 of the upper part of the perforation on the side of the conical surface is narrower than the lower part 32′ of the perforation on the rear side of the gear. This gives an advantage, if the press is used for compressing pulp which typically recovers its previous dimensions after physical manipulation. For such mass, the through passage is facilitated when the channel is provided with space for recovery of the pulp.

Furthermore, the properties of the perforation 28 can be changed. If it is desired that the material to be compressed assumes a given profile shape, by shaping the perforation 28 and modifying all the perforations of the sieve base disc 22, a modified base disc is provided, which can be used for compressing the pulp to form pressed pieces having a profile resembling, for example, a flower, a star, a snow flake, a cross, etc.

Uses for a shaped profile are found not only in view of appearance in the food industry but also in industrial pulp processing, where the properties of the pulp are to be modified by tearing, ripping, stretching, and otherwise physically modifying the pulp. For example in the compression of cellulose fibre, certain perforation patterns cause desirable fibrillation of the pulp.

In an embodiment of the invention, the force needed for processing the pulp is transmitted to the press apparatus by a bevel gear assembly by rotating a rotating shaft, such as the rotating shaft 34 in FIG. 3, around its rotation axis A so that one or more edge runner wheels having the shape of a bevel gear are moved by their toothing on top of a bevel gear shaped sieve base disc in such a way that the control of the bevel gear and the processing of the pulp on the race of the bevel gear are performed by means of the toothings of the bevel gear shaped sieve base disc and the bevel gear shaped edge runner wheel. The perforations of the sieve base disc are placed in at least such locations where the base disc comprises a tooth surface that is essential for the engagement of the bevel gears, but perforations may also be provided in such locations of the sieve base disc which are not necessary for the engagement of the gears. As a component, the sieve base disc may have any shape, but the tooth surface and thereby the pulp processing surface of the base disc follows a trajectory which can be drawn by rotating the rotation axis A. In general, the path meets the definition of an ellipse.

Furthermore, the press apparatus is encapsulated in a casing which allows the introduced pulp to pass through the press in such an unobstructed way that the pulp cannot accumulate on protrusions, fasteners or other dead angles obstructing the path of the pulp on the inner surfaces of the casing.

In an embodiment of the invention, the force needed for processing the pulp is transmitted to the press apparatus by a bevel gear assembly in such a way that the force needed for processing the pulp is transmitted to said bevel gear assembly by rotating a bevel gear shaped sieve base disc, such as the sieve base disc 22 in FIG. 3, around its rotation axis B in such a way that the controlling of a stationary bevel gear fixed to a supporting structure and the processing of the pulp on a circular path are performed by means of the toothings of the bevel gear shaped sieve base disc and the bevel gear shaped edge runner wheel. Also in this embodiment, the placement of the perforations in the sieve base disc is implemented at at least such points of the base disc which are provided with tooth surfaces which are essential for the engagement of the bevel gears, but perforations can be positioned in other parts of the base disc as well.

Also in this embodiment, the press apparatus is encapsulated in a casing which allows the introduced pulp to pass through the press in such an unobstructed way that the pulp cannot accumulate and pack up on protrusions, fasteners or other dead angles obstructing the path of the pulp on the inner surfaces of the casing.

In an embodiment of the invention, the same pulp is to be compressed several times in succession. Thus, feedback of the compressed pulp is used, whereby pulp, already once compressed, is driven via successive presses and/or an intermediate storage several times through the press.

Within the scope of its functional parameters, the press apparatus has a good fault tolerance, because the technology used is relatively simple and reliable. One embodiment of the invention provides a functional solution to a situation in which foreign matter has been entrained in the pulp to be compressed or the batch to be compressed has deteriorated and solidified. If the hardness of the foreign matter is close to the tensile strength of the press components, such situations involve a risk of damage to the press gears or failure of the motor that provides power transmission, if the foreign matter is wedged between the gears and jams the apparatus. In an embodiment of the invention, the rotating shaft or corresponding fastening structure, to which the edge runner is connected, is supplemented with a shear pin which allows the edge runner wheel, with its mounting, to rise from its pressing position in case of a failure of the above-described kind. The breaking threshold of the shear pin can be fitted to a safe level, wherein the motor and the press gears of the apparatus are not yet damaged.

Instead of a shear pin it is also possible to use a spring loaded or hydraulic arrangement, in which the edge runner wheel with its mounting is pressed by a spring loaded or hydraulic ram against the bevel gear like sieve base disc. The elastic constant of the spring is selected so that the force required for deviating the spring is lower than the force required for breaking the gears. In the case of a hydraulic ram, by monitoring the hydraulic pressure of the ram it is possible to quickly respond to eventual failure situations and to release the ram and thereby the mutual working positioning of the gears, and to prevent damage to the apparatus.

The invention is suitable for processing various kinds of pulp. It may involve mixing components or also a reaction between them in the pulp to be processed, which is thus a blend of two or more components. In general, pulps to be processed with the apparatus are characterized by a high dry matter content; in other words, they are in a paste-like or gel-like state, or solid with a given liquid content, to secure the processability of the pulp, but they are not yet liquids.

It should be taken into account that the technical features of the apparatus also improve the processing of wet pulps in the apparatus in such a way that the efficiency of the pressing process is also improved when such pulps are processed. Consequently, the invention can be used to improve both pulp processing of prior art and to expand uses to pulp types which have not been previously processable by presses in an efficient way.

The apparatus may be provided with a recirculation in such a way that the pulp compressed once through the base disc is recycled to the processing, and the pulp to be processed can thus be recirculated several times to the compressing process. In this way, the pulp will be processed several times, in view of the path of single particles or molecules in the process. One example is the production of cellulose carbamate, where cellulose fibres and urea and auxiliary agents are mixed at a low water content, and a reaction can be started already during continuous processing, where the same mixture is repeatedly compressed through perforations.

It is also possible to give the mixture to be processed a given shape, by means of the perforations. Thus, the mixture is not necessarily recirculated but the material goes through only one compressing step. The mixture can also be recirculated, but even in this case, the mixture remains, in the last step, in the cross-sectional shape defined by the perforations, after which drying can be performed, if necessary.

The apparatus according to the invention can be used, for example, in the chemical industry, in the food industry and, in general, in any processing industry where mixing and/or processing of materials is needed. Furthermore, uses for the apparatus can be found in the processing of various types of waste pulp and sludge in the field of municipal engineering. In particular, pulps which are based on biological material and have varying moisture contents, due to their hydrophilic nature, are suitable uses for the apparatus according to the invention. Typical examples of such uses include the processing and manufacture of modified cellulose and starch, such as wood chips and powders of mechanical wood processing.

It is obvious that the invention is not limited to the above-presented embodiments, but it can vary within the scope of the appended claims.

1. An apparatus for processing and compressing pulp, comprising a perforated sieve base disc , and at least one rotating roll wheel on top of the sieve base disc, rolling around the sieve base disc,
wherein
both the sieve base disc and said at least one rotating roller wheel rolling on the sieve base disc are shaped as bevel gears and are positioned to form a bevel gear assembly, by which a rotating force can be introduced in the gears of the bevel gear to be partly converted to a compressive force for compressing pulp to be processed through perforations in the bevel gear like sieve base disc and wherein the bevel gear used as the sieve base disc has the perforations both at the butt ends and at the tips of the teeth of the bevel gear, in the direction of the rotation axis B of the bevel gear, in such a way that the compressive force is transmitted to the pulp to be compressed in a direction perpendicular to the perforations, the edges of the teeth forming a trough like space for the pulp to be compressed.

2. The apparatus according to claim 1, in which the perforations in the bevel gear used as the sieve base disc have a wider cross-sectional profile on the rear side than on the conical side of the bevel gear.

3. The apparatus according to claim 1, in which the perforations extending through the bevel gear used as the sieve base disc are worked to correspond to a shape that gives the pulp to be compressed through the perforations a given profile.

4. The apparatus according to claim 1, in which the perforations extending through the bevel gear used as the sieve base disc are worked to correspond to a shape that produces a structural transformation of the pulp, by shearing or tearing the pulp passing through.

5. The apparatus according to claim 1, wherein compression is provided at the contact points of the tooth surfaces of the bevel gears, subjecting the pulp to be compressed to a compressive force which causes the compression of the pulp to be processed through the perforations in the bevel gear like sieve base disc.

6. The apparatus according to claim 1, wherein the bevel gears are placed at such a distance from each other that the bevel gears, when intermeshing and rotating, subject the teeth touching each other to not only a compressive force but also a force that brings the bevel gear to a rotating motion.

7. The apparatus according to claim 1, wherein the force required for processing the pulp is transmitted to said bevel gear assembly by rotating the rotating shaft and one or more bevel gears connected to it, around the rotation axis of the rotating shaft in such a way that one or more bevel gears connected to the shaft move by their toothing on the bevel gear like sieve base disc in such a way that the control of the bevel gear on the circular path is performed by means of toothings of the bevel gear shaped sieve base disc and the bevel gear shaped bevel gear.

8. The apparatus according to claim 1, wherein the force required for processing the pulp is transmitted to said bevel gear assembly by rotating the bevel gear shaped base disc around its rotation axis in such a way that the control of the bevel gear on the circular path is performed by means of the toothings of the bevel gear shaped sieve base disc and the bevel gear shaped bevel gear.

9. The apparatus according to claim 7, wherein the fitting of the bevel gears to each other is performed so that the mutual distance between the toothings of the bevel gears can be changed, due to the triggering of a hydraulic ram, a spring damper or a shear pin, in situations in which material whose hardness is close to the material hardness of the bevel gears and which may cause breaking of the bevel gears or overloading of the driving power source, has been entrained between the bevel gears.

10. The apparatus according to claim 1, comprising a casing designed in such a way that the pulp passing from the upper part of the casing to the processing space is guided without obstruction to the space between the working gears, without accumulating in the structures of the casing.

11. The apparatus according to claim 1, comprising feedback of the compressed pulp to the press, for re-compressing the pulp.

12. A method for processing and compressing pulp, the method comprising:
rotating at least one roll wheel on top of a perforated sieve base disc , in the direction of the periphery of the base disc,
applying a press arrangement where a bevel gear assembly has been made of a sieve base disc and a roll wheel, both shaped as a bevel gear, where the bevel gears are positioned in such a way to each other that the teeth of the bevel gears direct a compressive force on the planar surfaces of the tooth modules,
introducing a rotating force in the bevel gear by means of the teeth the bevel gears, to be partly converted to a compressive force,
pressing the pulp to be processed through perforations in the bevel gear like sieve base disc,
applying part of the rotating force introduced in the gear for moving the above-mentioned bevel gears in relation to each other, and
working the perforations of the bevel gear used as a sieve base plate both at the butt ends and at the tips of the teeth of the bevel gear, in the direction of the rotation axis of the bevel gear, in such a way that the compressive force is transmitted to the pulp to be compressed in a direction perpendicular to the perforations, the edges of the teeth forming a trough-like space for the pulp to be compressed.

13. The method according to claim 12, comprising
transmitting a force for processing the pulp to said bevel gear assembly,
rotating a rotating shaft and one or more bevel gears connected to it around the rotation axis of the rotating shaft in such a way that said one or more bevel gears connected to the shaft move by means of their toothing on top of the bevel gear shaped sieve base disc.

14. The method according to claim 12, comprising
transmitting the force required for processing the pulp to said bevel gear assembly,
rotating the bevel gear shaped sieve base disc around its rotation axis in such a way that one or more bevel gears connected on the bevel gear shaped sieve base disc remains in the same position with respect to the apparatus.

15. The method according to claim 12, comprising
working perforations in the bevel gear used as the sieve base disc, the cross-sectional profile of the perforations being wider on the rear side than the conical side of the bevel gear.

16. The method according to claim 12, comprising
working the perforations extending through the bevel gear used as the sieve base disc to correspond to a shape that gives the pulp to be compressed through the perforations a given profile.

17. The method according to claim 12, comprising
working the perforations extending through the bevel gear used as the sieve base disc to correspond to a shape that produces a structural transformation of the pulp, by shearing or tearing the pulp passing through.

18. The method according to claim 12, comprising
providing compression at the points of contact between the tooth surfaces of the bevel gears against the tooth surfaces,
subjecting the pulp to be compressed to a compressive force which causes pressing of the pulp to be processed through perforations in the bevel gear like sieve base disc.

19. The method according to claim 12, comprising
arranging the bevel gears at such a distance from each other that the bevel gears, when intermeshing and rotating, subject the teeth touching each other to not only a compressive force and further a force that brings the bevel gear to a rotating motion.

20. The method according to claim 13, comprising
fitting the bevel gears to each other so that the mutual distance between the toothings of the bevel gears can be changed, due to the triggering of a hydraulic ram, a spring damper or a shear pin, in situations in which material whose hardness is close to the material hardness of the bevel gears and which may cause breaking of the bevel gears or overloading of the driving power source, has been entrained between the bevel gears.

21. The method according to claim 12, comprising
designing a casing to protect the arrangement in such a way that the pulp passing from the upper part of the casing to the processing space is guided to the space between the working bevel gears in an unobstructed way, without accumulating in the structures of the casing.

22. The method according to claim 12, comprising
arranging feedback of the compressed pulp to the press, for re-compressing the pulp.
